(19) United States
(12) Patent Application Publication
(10) Pub. No.: US 2019/0296873 A1
(43) Pub. Date: Sep. 26, 2019

(54) TECHNIQUES FOR CONFIGURING CHANNEL STATE INFORMATION (CSI) PROCESS FOR A COORDINATED SET OF TRANSMISSION RECEPTION POINTS

(71) Applicant: QUALCOMM Incorporated, San Diego, CA (US)

(72) Inventors: Piyush GUPTA, Bridgewater, NJ (US); Junyi LI, Chester, NJ (US); Chong LI, Weehawken, NJ (US)

(21) Appl. No.: 16/295,388

(22) Filed: Mar. 7, 2019

Related U.S. Application Data
(60) Provisional application No. 62/647,902, filed on Mar. 26, 2018.

(51) Int. Cl. H04L 5/00; H04B 7/024

(52) U.S. Cl. CPC H04L 5/0048; H04B 7/024

(57) ABSTRACT

Methods, systems, and devices for wireless communications are described techniques for configuring channel state information (CSI) process for a coordinated set of transmission reception points. The techniques for configuring channel state information (CSI) process for a coordinated set of transmission reception points may include receiving a sounding reference signal (SRS) and identifying, based at least in part on the SRS, a first CoMP set of TRPs. The techniques for configuring channel state information (CSI) process for a coordinated set of transmission reception points may also include transmitting a CSI-RS to a UE and receiving CSI from the UE. The techniques for configuring channel state information (CSI) process for a coordinated set of transmission reception points may further include identifying, based at least in part on the CSI, a second CoMP set of TRPs.

### CLAIM OF PRIORITY UNDER 35 U.S.C. § 119

This application claims the benefit of Provisional Patent Application Ser. No. 62/647,902 entitled “TECHNIQUES FOR CONFIGURING CHANNEL STATE INFORMATION (CSI) PROCESS FOR A COORDINATED SET OF TRANSMISSION RECEPTION POINTS” which was filed on Mar. 26, 2018. The aforementioned application is hereby expressly incorporated herein by reference in its entirety.

### FIELD OF THE DISCLOSURE

The following relates generally to wireless communication, and more specifically to techniques for configuring channel state information (CSI) process for a coordinated set of transmission reception points.

### DESCRIPTION OF RELATED ART

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

Some wireless communications systems may use coordinated multipoint (CoMP) techniques in which various base stations of a coordinated set within the system may coordinate the transmission and reception of communications between the base stations and the UEs of the system. The base stations may dynamically coordinate to provide joint scheduling and transmissions as well as joint processing of the received signals. In this way, a UE is able to be served by two or more base stations, which may help to improve transmission and reception signals and increase throughput. In cases where CoMP systems may experience interference or other communication issues between a UE and a base station, another base station of a coordinated set may be able to provide more reliable communications. Efficient techniques for use in a CoMP system that accounts for the performance demands of varying operating channel conditions may be desirable to help enhance system performance.

### SUMMARY

The described techniques relate to improved methods, systems, devices, or apparatuses that support techniques for configuring channel state information (CSI) process for a coordinated set of transmission reception points. Various described techniques for configuring channel state information (CSI) process for a coordinated set of transmission reception points. In some examples, techniques for configuring channel state information (CSI) process for a coordinated set of transmission reception points may include receiving, by a transmission point, a sounding reference signal (SRS) and identifying, by the transmission point and based at least in part on the SRS, a first coordinated multiple-point (CoMP) set of transmission points. The techniques for configuring channel state information (CSI) process for a coordinated set of transmission reception points may also include transmitting, by the transmission point, a channel state information reference signal (CSI-RS) to a user equipment (UE) and receiving, by the transmission point, channel state information (CSI) from the UE. The techniques for configuring channel state information (CSI) process for a coordinated set of transmission reception points may further include identifying, by the transmission point based at least in part on the CSI, a second CoMP set of transmission points.

In some aspects, the first CoMP set of transmission points may include a subset of a plurality of transmission points that received the SRS. In other aspects, the first CoMP set of transmission points may include all of a plurality of transmission points that received the SRS. The techniques for configuring channel state information (CSI) process for a coordinated set of transmission reception points may further include identifying one or more CSI processes for the first CoMP set of transmission points. In an example, identifying one or more CSI processes for the first CoMP set of transmission points may include identifying all combinations of CSI processes for a plurality of transmission points of the first CoMP set of transmission points. In another example, identifying one or more CSI processes for the first CoMP set of transmission points may include identifying a subset combination of CSI processes for a plurality of transmission points of the first CoMP set of transmission points. In an example, the first CoMP set of transmission points may include a great number of transmission points than the second CoMP set of transmission points.

In some aspects, the techniques for configuring channel state information (CSI) process for a coordinated set of transmission reception points may include transmitting, by a user equipment, a sounding reference signal (SRS). The techniques for configuring channel state information (CSI) process for a coordinated set of transmission reception points may also include receiving, by the user equipment, one or more channel state information reference signals (CSI-RS) from a first coordinated multiple-point (CoMP) set of transmission points. For example, the first CoMP set of transmission points may be determined based at least in part on the SRS. The techniques for configuring channel state information (CSI) process for a coordinated set of transmission reception points may further include reporting, by the user equipment, channel state information (CSI) to the one or more transmission points.

In some aspects, the one or more transmission points may include a subset of a plurality of transmission points that received the SRS. In another example, the one or more transmission points may include all of a plurality of transmission points that received the SRS. The techniques for configuring channel state information (CSI) process for a coordinated set of transmission reception points may further include receiving CoMP transmissions from a second CoMP set of transmission points. For example, the second CoMP set of transmission points is different from the first CoMP set of transmission points.

In some aspects, techniques for configuring channel state information (CSI) process for a coordinated set of transmission reception points may include means for receiving a sounding reference signal (SRS) and means for identifying, based at least in part on the SRS, a first coordinated multiple-point (CoMP) set of transmission points. The techniques for configuring channel state information (CSI) process for a coordinated set of transmission reception points may also include means for transmitting a channel state information reference signal (CSI-RS) to a user equipment (UE) and means for receiving channel state information (CSI) from the UE. The techniques for configuring channel state information (CSI) process for a coordinated set of transmission reception points may further include means for identifying, based at least in part on the CSI, a second CoMP set of transmission points.

In some aspects, the first CoMP set of transmission points may include a subset of a plurality of transmission points that received the SRS. In another aspects, the first CoMP set of transmission points may include all of a plurality of transmission points that received the SRS. The techniques for configuring channel state information (CSI) process for a coordinated set of transmission reception points may further include means for identifying one or more CSI processes for the first CoMP set of transmission points. In an example, the means for identifying one or more CSI processes for the first CoMP set of transmission points may include means for identifying all combinations of CSI processes for a plurality of transmission points of the first CoMP set of transmission points. In another example, the means for identifying one or more CSI processes for the first CoMP set of transmission points may include means for identifying a subset combination of CSI processes for a plurality of transmission points of the first CoMP set of transmission points. In an aspect, the first CoMP set of transmission points may include a great number of transmission points than the second CoMP set of transmission points.

In some aspects, the techniques for configuring channel state information (CSI) process for a coordinated set of transmission reception points may include means for transmitting a sounding reference signal (SRS). The techniques for configuring channel state information (CSI) process for a coordinated set of transmission reception points may also include means for receiving one or more channel state information reference signals (CSI-RS) from a first coordinated multiple-point (CoMP) set of transmission points. For example, the first CoMP set of transmission points may be determined based at least in part on the SRS. The techniques for configuring channel state information (CSI) process for a coordinated set of transmission reception points may further include means for reporting channel state information (CSI) to the one or more transmission points.

In some aspects, the one or more transmission points may include a subset of a plurality of transmission points that received the SRS. In another aspect, the one or more transmission points may include all of a plurality of transmission points that received the SRS. The techniques for configuring channel state information (CSI) process for a coordinated set of transmission reception points may further include means for receiving CoMP transmissions from a second CoMP set of transmission points. For example, the second CoMP set of transmission points may be different from the first CoMP set of transmission points.

In some aspects, techniques for configuring channel state information (CSI) process for a coordinated set of transmission reception points may include a processor, a memory in electronic communication with the processor, and instructions stored in the memory and executable by the processor to cause the apparatus to receive a sounding reference signal (SRS) and identify, based at least in part on the SRS, a first coordinated multiple-point (CoMP) set of transmission points. The techniques for configuring channel state information (CSI) process for a coordinated set of transmission reception points may include transmit a channel state information reference signal (CSI-RS) to a user equipment (UE) and receive channel state information (CSI) from the UE. The techniques for configuring channel state information (CSI) process for a coordinated set of transmission reception points may further include identify, based at least in part on the CSI, a second CoMP set of transmission points.

In some aspects, the first CoMP set of transmission points may include a subset of a plurality of transmission points that received the SRS. In another aspects, the first CoMP set of transmission points may include all of a plurality of transmission points that received the SRS. The techniques for configuring channel state information (CSI) process for a coordinated set of transmission reception points may further include identify one or more CSI processes for the first CoMP set of transmission points. In an aspect, identify one or more CSI processes for the first CoMP set of transmission points may include identifying all combinations of CSI processes for a plurality of transmission points of the first CoMP set of transmission points. In another aspect, identify one or more CSI processes for the first CoMP set of transmission points may include identifying a subset combination of CSI processes for a plurality of transmission points of the first CoMP set of transmission points. For example, the first CoMP set of transmission points may include a great number of transmission points than the second CoMP set of transmission points.

In some aspects, techniques for configuring channel state information (CSI) process for a coordinated set of transmission reception points may include a processor, a memory in electronic communication with the processor, and instructions stored in the memory and executable by the processor to cause the apparatus to: transmit a sounding reference signal (SRS). The techniques for configuring channel state information (CSI) process for a coordinated set of transmission reception points may also include receive one or more channel state information reference signals (CSI-RS) from a first coordinated multiple-point (CoMP) set of transmission points. For example, the first CoMP set of transmission points may be determined based at least in part on the SRS. The techniques for configuring channel state information (CSI) process for a coordinated set of transmission reception points may further include report channel state information (CSI) to the one or more transmission points.

In some aspects, the one or more transmission points may include a subset of a plurality of transmission points that received the SRS. In another aspect, the one or more transmission points may include all of a plurality of transmission points that received the SRS. The techniques for configuring channel state information (CSI) process for a coordinated set of transmission reception points may further include receive CoMP transmissions from a second CoMP set of transmission points. For example, the second CoMP set of transmission points may be different from the first CoMP set of transmission points.

In some aspects, the techniques for configuring channel state information (CSI) process for a coordinated set of transmission reception points may include a non-transitory computer-readable medium storing code for wireless communication, the code may include instructions executable by a processor to: receive a sounding reference signal (SRS) and identify, based at least in part on the SRS, a first coordinated multiple-point (CoMP) set of transmission points. The techniques for configuring channel state information (CSI) process for a coordinated set of transmission reception points may also include transmit a channel state information reference signal (CSI-RS) to a user equipment (UE) and receive channel state information (CSI) from the UE. The techniques for configuring channel state information (CSI) process for a coordinated set of transmission reception points may further include identify, based at least in part on the CSI, a second CoMP set of transmission points.

In some aspects, the first CoMP set of transmission points may include a subset of a plurality of transmission points that received the SRS. In another aspect, the first CoMP set of transmission points may include all of a plurality of transmission points that received the SRS. The techniques for configuring channel state information (CSI) process for a coordinated set of transmission reception points identify one or more CSI processes for the first CoMP set of transmission points. In an example, identify one or more CSI processes for the first CoMP set of transmission points may include identify all combinations of CSI processes for a plurality of transmission points of the first CoMP set of transmission points. In another example, identify one or more CSI processes for the first CoMP set of transmission points may include identify a subset combination of CSI processes for a plurality of transmission points of the first CoMP set of transmission points. In an aspect, the first CoMP set of transmission points may include a great number of transmission points than the second CoMP set of transmission points.

In some aspects, techniques for configuring channel state information (CSI) process for a coordinated set of transmission reception points may include a non-transitory computer-readable medium storing code for wireless communication, the code may include instructions executable by a processor to: transmit a sounding reference signal (SRS). The techniques for configuring channel state information (CSI) process for a coordinated set of transmission reception points may also include receive one or more channel state information reference signals (CSI-RS) from a first coordinated multiple-point (CoMP) set of transmission points. For example, the first CoMP set of transmission points may be determined based at least in part on the SRS. The techniques for configuring channel state information (CSI) process for a coordinated set of transmission reception points may further include report channel state information (CSI) to the one or more transmission points.

In some aspects, the one or more transmission points may include a subset of a plurality of transmission points that received the SRS. In another aspect, the one or more transmission points may include all of a plurality of transmission points that received the SRS. The techniques for configuring channel state information (CSI) process for a coordinated set of transmission reception points may further include receive CoMP transmissions from a second CoMP set of transmission points. For example, the second CoMP set of transmission points may be different from the first CoMP set of transmission points.

Some examples of the method, apparatus, and non-transitory computer-readable medium described above may further include processes, features, means, or instructions for identifying a SPS configuration for two or more other UEs that may be associated with the one or more different TRPs of the group of TRPs, and wherein the configuring the second set of NOMA uplink resources may be based at least in part on the SPS configuration.

### BRIEF DESCRIPTION OF THE DRAWINGS

FIG. 1 illustrates an example of a system for wireless communication that supports techniques for configuring CSI process for a coordinated set of transmission reception points in accordance with aspects of the present disclosure.

FIG. 2 illustrates an example of a portion of a wireless communication system that supports techniques for configuring CSI process for a coordinated set of transmission reception points in accordance with aspects of the present disclosure.

FIG. 3 illustrates an example of a coordinated set that supports techniques for configuring channel state information (CSI) process for a coordinated set of transmission reception points in accordance with aspects of the present disclosure.

FIGS. 4 and 5 show block diagrams of a device that supports techniques for configuring channel state information (CSI) process for a coordinated set of transmission reception points in accordance with aspects of the present disclosure.

FIGS. 6 and 7 show block diagrams of a device that supports techniques for configuring channel state information (CSI) process for a coordinated set of transmission reception points in accordance with aspects of the present disclosure.

FIGS. 8 and 9 illustrate methods for configuring channel state information (CSI) process for a coordinated set of transmission reception points in accordance with aspects of the present disclosure.

### DETAILED DESCRIPTION

In a coordinated wireless communication system, multiple transmission reception points (TRPs) in a set may support communication with a user equipment (UE). The one or more TRPs in a set may coordinate scheduling and communications with one another (e.g., directly via backhaul links or through a coordinating entity such as a base station or core network node). Various described techniques provide for multiple TRPs in a set may configure channel state information (CSI) process for communication with a UE. In some cases, a user equipment may broadcast a sounding reference signal (SRS) one or more neighboring TRPs. Each of the neighboring TRPs that received the SRS may access and determine a channel state between the TRP and the user equipment. The neighboring TRPs may transmit the channel state information derived from the SRS to a coordinating entity (e.g., a grand master, a multicell/multicast coordination entity (MCE), a node within the core network, etc.). The coordinating entity may determine a first CoMP set of TRPs for communications with the user equipment. In another example, the neighboring TRPs may communicate the channel state information derived from the SRS to each other. The neighboring TRPs may identify a first CoMP set of TRPs for communications with the user equipment. In an example, the CoMP set of TRPs may include a subset of neighboring TRPs that received the SRS from the user equipment.

In some cases, more detailed channel state information may be needed in order to maintain a reliable CoMP set of TRPs due to the change in the environment (e.g., fast shadowing). For example, each of the TRPs in the first CoMP set may transmit a channel state information reference signal (CSI-RS) to the user equipment. The user equipment may measure a channel condition using the CSI-RS and report the channel condition (e.g., channel quality indicator (CQI)) to each of the TRPs in the first CoMP set. Each TRPs in the first CoMP set may determine a CSI interference measurement (CSI-IM) based at least in part on the channel condition report provided by the user equipment. Each of the TRPs in the first CoMP set may provide/report the CSI-IM to the coordinating entity. The coordinating entity may determine a second CoMP set of TRPs for communication with user equipment based at least in part on the CSI-IM provided by each TRPs in the first CoMP set.

In some cases, such techniques for configuring CSI process may be used in wireless communications systems that implement ultra-reliable low latency communications (URLLC), which may allow for increased data rates and higher throughput for wireless communications. Some of these systems may provide for a high reliability rate (e.g., 10⁻⁶ error rate) within a 1-10 millisecond (ms) cycle time, such as in an Internet of Things (IoT) system. For example, UEs within some industrial IoT settings may communicate periodic traffic within deterministic synchronous cycles. These UEs may transmit and receive small payloads, which may allow for a large number of UEs to operate within the IoT system. Backhaul links, such as those between different TRPs in the IoT system, may be fast, reliable, and deterministic (e.g., Time-Sensitive Networking (TSN) and/or Integrated Access and Backhaul (IAB)), allowing for communications between TRPs to have high throughput and data rates.

UEs operating in the IoT system, however, may also be limited to a short communication range and may face challenging propagation scenarios due to the nature of the operating environment. For example, in some industrial IoT settings, there may be fast moving parts, machines, or devices within a particular operating environment, which may result in fast shadowing and interference. Further, UEs may experience interference from faraway transmissions, which may be rapidly varying due to reflection within the industrial environment. Additionally, the mobility of the UEs may be limited in terms of speed, range, and randomness. Due to the difficult environment of such industrial IOT systems, some systems may provide that spatial diversity may be utilized for URLLC communications. Spatial reuse, however, may require coordinated communications between various TRPs (e.g., in a coordinated multi-point (CoMP) system) to ensure that spatial reuse efforts may not inadvertently increase inter cell interference (ICI).

The described techniques relate to the coordinated set of transmission reception points in a coordinated multipoint (CoMP) system. By leveraging the communication links in an IoT system (e.g., backhaul communication links), one or more UEs in the CoMP system may be within a coverage area supported by a coordinated set of TRPs. Some sets of TRPs may overlap and in such instances, different frequencies may be utilized to help mitigate interference between different sets. Each coordinated set of TRPs may support communication for a UE via multiple TRPs and/or a single TRP may be part of multiple sets. To support communications over different sets, a TRP may be configured to communicate using resources specified for each set of coordinated TRPs. The TRP may, in some examples, be an independent base station or a group of TRPs may be controlled by a single base station or coordinating entity (e.g., a grand master).

Aspects of the disclosure are initially described in the context of a wireless communications system. Aspects of the disclosure are further illustrated by and described with reference to apparatus diagrams, system diagrams, and flowcharts that relate to techniques for configuring channel state information (CSI) process for a coordinated set of transmission reception points.

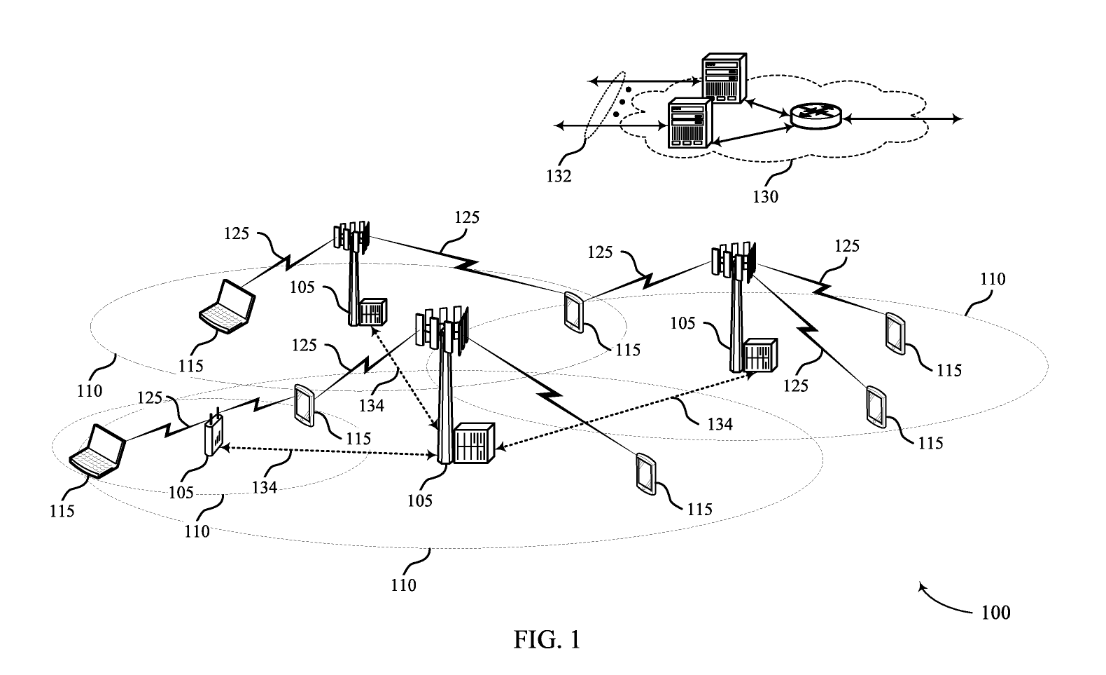

FIG. 1 illustrates an example of a wireless communications system 100 for configuring CSI process in a coordinated set of transmission reception points in accordance with various aspects of the present disclosure. The wireless communications system 100 may include base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices. In some cases, base stations 105 and UEs 115 may be configured in coordinated sets in which base stations 105 may configure CSI process for coordinated/joint communication with UEs 115 in accordance with techniques such as discussed herein.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions).

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In some examples, the wireless communications system 100 may use CoMP techniques for UEs 115 operating within a coverage area of multiple base stations 105, or TRPs. In some cases, CoMP techniques may employ coordinated scheduling (CS) and coordinated beamforming (CB). Systems employing CS may divide a network into multiple sets. Each set may employ centralized scheduling in order to determine which TRPs 105 within the set communicate with a UE 115 in each time duration (e.g., subframe, slot, mini-slot, symbol). Systems employing CB may calculate power level and beamforming coefficients in order to achieve common signal to interference plus noise ratios (SINRs) in the system or to improve the minimum SINR for one or more UEs 115. This may be referred to as dynamic point blanking (DPB). In CS/CB systems, the multiple TRPs 105 may share channel state information (CSI) for various UEs 115, while data packets specific to a UE 115 data packets may be provided by a single TRP 105. For example, in a system supporting semi-static point selection (SSPS), a first TRP 105 may send a first data packet to a UE 115 and a second TRP 105 may send a second data packet to the UE 115, but a single data packet may not be sent by more than one TRP 105.

In some cases, wireless communications system 100 may be a CoMP system that employs joint-processing (JP). In a JP-CoMP system, data may be available for a UE 115 at more than one TRP 105 for the same time-frequency resources. JP-CoMP systems may be classified into joint transmission (JT) systems and dynamic point selection (DPS) systems. In JT-CoMP systems, multiple TRPs 105 may transmit data to the UE 115 simultaneously. The multiple TRPs 105 may each send the same data to the UE, which may provide a more powerful signal at the UE 115. Additionally or alternatively, each TRP 105 may send different data, which the UE 115 may combine in order to receive more data or additional coded bits corresponding to a data packet to correct bit errors (e.g., in a HARQ procedure).

A CoMP-DPS system may allow a UE 115 to be dynamically scheduled by the TRP 105 having sufficient (e.g., highest) channel quality conditions for communications with the UE 115. This dynamic scheduling may be done by exploiting changes in the channel fading condition. In a CoMP-DPS system, transmission of beamformed data may be performed at a single TRP 105. The selected TRP 105 may notify the other cooperating TRPs 105 (e.g., via an X2 interface) of its communications with the UE 115. This notification may cause the cooperating TRPs 105 to mute the resources that the selected TRP 105 may use for communications with the UE 115. In some examples, the notification via the X2 interface may between 20 ms and 40 ms to be delivered to the cooperating TRPs 105, which may be relatively slow compared to other communications links between multiple TRPs 105.

In CoMP-DPS communication systems, the communications between a TRP 105 and a UE 115 may experience shadowing. Shadowing may occur when the received power of a signal fluctuates due to objects obstructing the propagation path between a TRP 105 and a UE 115. In some wireless communications systems, shadowing may be relatively slow when compared to intra-TRP 105 communications. In order to overcome this, a UE 115 may strategically choose a TRP 105 such that communications may be maintained. However, in some cases, communications between a TRP 105 and a UE 115 may experience fast shadowing. Fast shadowing may occur when communications between a TRP 105 and a UE 115 experience frequent and sizeable changes in shadowing. For example, a UE 115 in an industrial environment may experience reflection (e.g., as a result of blockage from some moving physical object such as a robotic arm). In such an example, the decorrelation distance may be as small 0.2 m which may translate to 10 ms of blockage given a UE 115 speed of 20 m/s.

In some cases, reliability of communications between a set of TRPs 105 and a UE 115 may be achieved through spatial diversity (e.g., at a scale of shadowing and/or coordinated transmission). In some other cases, in order to maintain a CoMP set of TRPs 115 for serving a UE 115 with high reliability, channel state information (CSI) may be needed from a large number of TRPs 115. Various techniques as discussed herein for configuring channel state information (CSI) process for a coordinated set of TRPs 115 for supporting CoMP communications.

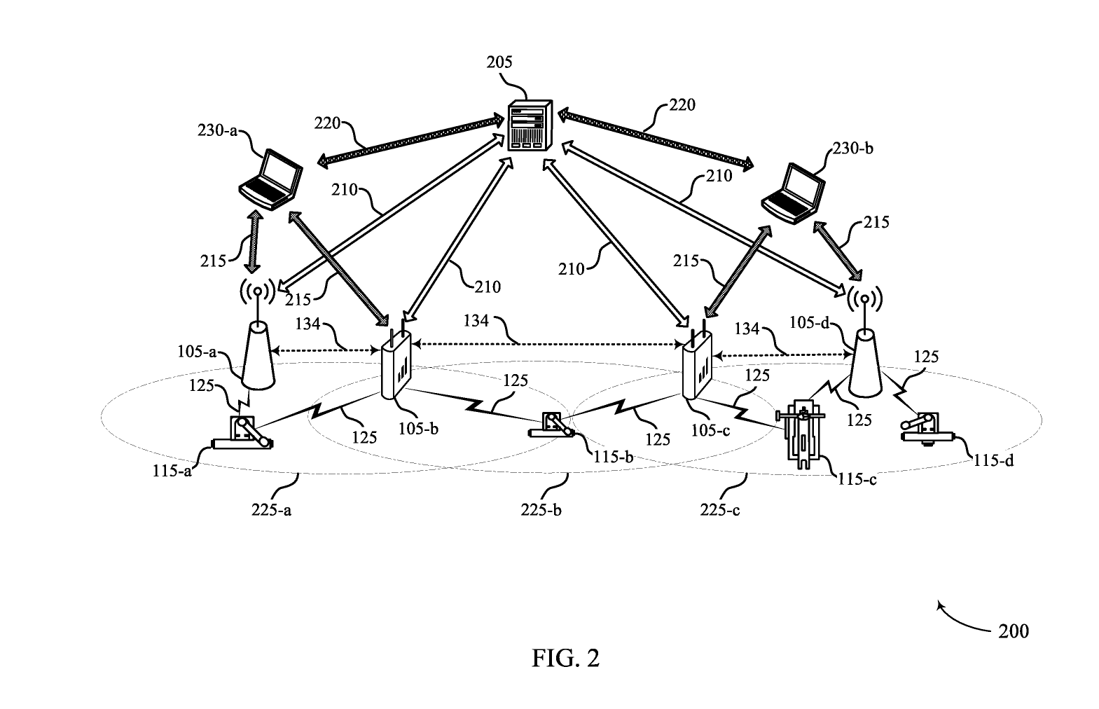

FIG. 2 illustrates an example of a portion of a wireless communications system 200 that supports feedback transmission techniques in coordinated sets of transmission reception points in accordance with various aspects of the present disclosure. In some examples, wireless communications system 200 may implement aspects of wireless communication system 100. In wireless communications system 200, a coordinating entity 205 (e.g., a grand master, a multicell/multicast coordination entity (MCE), a node within the core network 130, etc.) may determine a number of coordinated sets 225 for communications with a number of different UEs 115. In some cases, the wireless communications system 200 may be located in an industrial setting, and each of the UEs 115 may be associated with a piece of equipment within the industrial setting, although techniques provided herein may be used in any on a number of other deployment scenarios.

In the example of FIG. 2, each coordinated set 225 may include multiple TRPs 105 capable of communicating with one or more UEs 115 within the coordinated set 225. The TRPs 105 may be any one of a base station, an eNB, a gNB, an IoT gateway, a cell, etc. In some examples, the coordinated sets 225 may be determined based on measurements of channel conditions (or other statistics) between the UEs 115 and one or more TRPs 105. As shown in FIG. 2, TRPs 105-a and 105-b support communications with multiple UEs 115, such as UE 115-a within coordinated set 225-a. TRPs 105-b and 105-c support communications with multiple UEs 115, such as UE 115-b within coordinated set 225-b. TRPs 105-c and 105-d support communications with multiple UEs 115, such as UEs 115-c and 115-d within coordinated set 225-c.

The TRPs 105 may communication with a management system (e.g., a coordinating entity 205) via links 210, which may configure the different coordinated sets 225, in some examples. The management system may include, for example, an industrial PC which may provide controller programming for different UEs 115, software and security management of the wireless communications system 200, long term key performance indicator (KPI) monitoring, among other functions. In the example of FIG. 2, the TRPs 105 may also communicate with human-machine-interfaces (HMIs) 230 via communications links 215 and HMIs 230 may communicate with coordinating entity 205 (or other management system) via links 220. HMIs 230 may include, for example, tablet computers, control panels, wearable devices, control computers, and the like, which may provide control for different equipment within the system (e.g., start/stop control, mode change control, augmented or virtual reality control, etc., for a piece of equipment that may include a UE 115).

In some cases, TRPs 105 may include programmable logic controllers (PLCs) that may issue a series of commands (e.g., motion commands for a piece of equipment), receive sensor inputs (e.g., position of a robotic arm of a piece of equipment), and coordinate with other PLCs. In such cases, the wireless communications between the TRPs 105 and UEs 115 may need to provide near real-time information, and may use URLLC communications techniques. In such cases, inter TRP 105 communications may have somewhat more relaxed latency requirements, and communications between the TRPs 105 and coordinating entity 205 or HMIs 230 may have even more related latency requirements and may use, for example, eMBB communications techniques.

In some cases, the TRPs 105 that are members of a given coordinated set 225 may change. For instance, the channel conditions for a UE 115 may change over time due to location of the UE 115, speed or movement of the UE 115, interference or signal quality variations between a UE 115 and one or more TRPs 105. In such cases, periodic or aperiodic (e.g., triggered) measurement reports may be sent from a UE 115 to one or more TRPs 105. The TRPs 105 may coordinate amongst themselves or may be coordinated by a separate entity (e.g., a coordinating entity 205) to determine which TRPs 105 are to support communication for a coordinated set 225 of the UE 115. The coordinating entity 205 may inform the TRPs 105 of this determination, and the TRPs 105 selected for the set may communicate with the UEs 115 over the same set of time-frequency resources.

In some cases, the coordinating entity 205 may also assign a resource pool of each of the set of TRPs 105 based on the channel condition measurements. The selected TRPs of a dynamic set, such as the TRPs 105-c and 105-d in a coordinated set 225-c, may use different resources (e.g., different physical resource blocks (PRBs)) for communications with associated UEs 115. The UEs 115 may also be signaled on a dedicated downlink resource of a resource pool to be used for communication in their assigned coordinated set 225 and associated resources for downlink and uplink transmissions. The UEs 115 may be signaled by the coordinating entity 205 or one more TRPs 105 in the coordinated sets 225.

As indicated above, in some cases, within coordinated set 225, communications between TRP 105 and UE 115 may experience fast shadowing or fast fading. Fast shadowing may occur when communications between a TRP 105 and a UE 115 experience frequent and sizeable changes in shadowing. For example, in some cases, the UE 115 may be in an industrial environment and experience reflection (e.g., as a result of blockage from some moving physical object such as a robotic arm).

In a fast shadowing or fading environment, a reliable CoMP set of TRPs 105 may include a numerous TRPs 105 in order to achieve a desired packet error rate and/or latency requirement. As a number of TRPs 105 in a CoMP set increases, a number of CSI processes may increase exponentially (e.g., corresponding to different transmitting (Tx) states of the TRPs 105). Thus, an efficient technique for configuring channel state information (CSI) processes from a plurality of TRPs in a CoMP set is discussed below. In some examples, a UE 115 may broadcast one or more sounding reference signal (SRS) to one or more neighboring TRPs 105. The one or more neighboring TRPs 105 may measure a channel quality of an uplink communication channel between the UE 115 and the one or more neighboring TRPs 105 based at least in part on the SRS.

The one or more neighboring TRPs 105 may provide the measured channel quality of the uplink communication channel to a coordinating entity 205 (e.g., a grand master, a multicell/multicast coordination entity (MCE). The coordinating entity 205 may determine a first CoMP set of TRPs 105 based at least in part on the measured channel quality of the uplink communication channel. For example, the coordinating entity 205 may select one or more TRPs 105 that reported a measured channel quality of the uplink communication channel above a threshold to be included in the first CoMP set of TRPs 105. In another example, the one or more neighboring TRPs 105 may negotiate amongst each other to determine a first CoMP set of TRPs 105. For example, the one or more neighboring TRPs 105 that received the SRS from the UE 115 may provide the respective measured channel quality of the uplink communication channel to each other. The one or more neighboring TRPS 105 may negotiate and form a first CoMP set of TRPs 105. The first CoMP set of TRPs 105 may include one or more TRPS 105 having a measured channel quality of the uplink communication channel above a threshold.

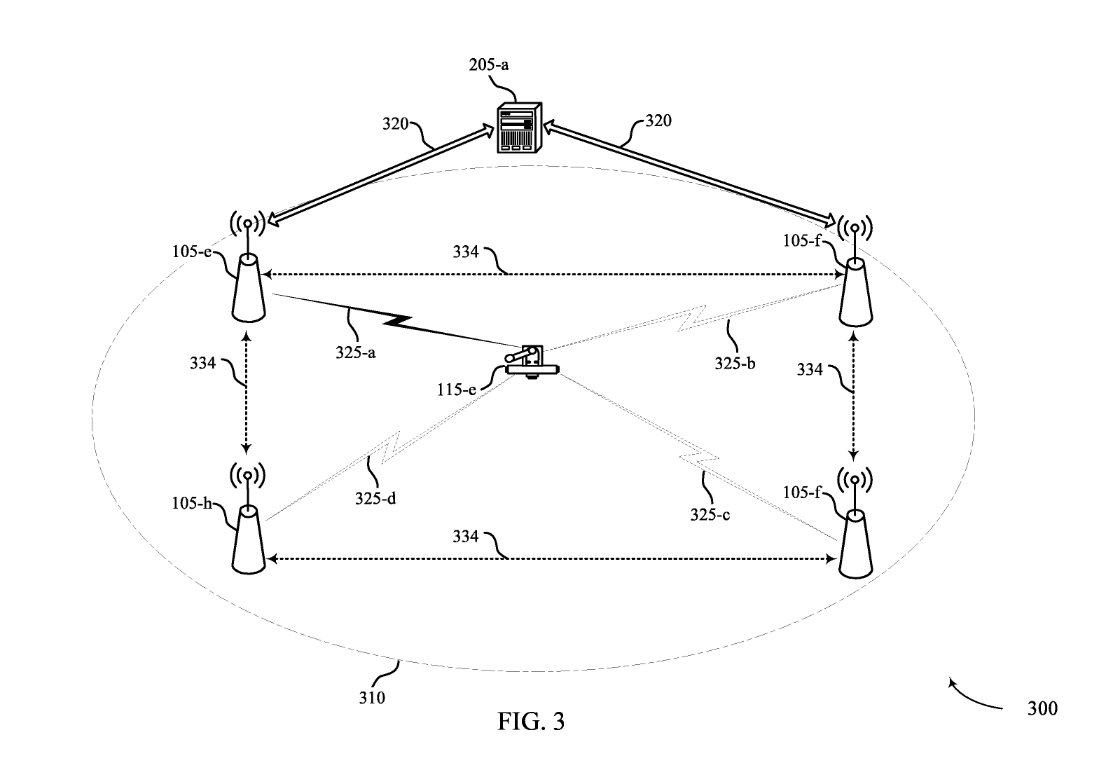

In some aspects, the first CoMP set of TRPs 105 may include a subset of one or more neighboring TRPs 105 that received the SRS from the UE 115. The TRPs 105 of the first CoMP set may identify all combination of CSI processes for the first CoMP set of TRPs 105. With a subset of one or more neighboring TRPs 105 included in the first CoMP set, a number (e.g., all combination) of CSI processes may be reduced when comparing to a number of CSI processes for all one or more neighboring TRPs 105. In another example, the TRPs 105 of the first CoMP set may identify a subset of all combination of CSI processes for the first CoMP set of TRPs 105. In other aspects, the first CoMP set of TRPs 105 may include all of the one or more neighboring TRPs 105 that received the SRS from the UE 115 when the measured channel quality of the uplink communication channel is above a threshold. Examples of techniques for configuring channel state information (CSI) process for a coordinated set of transmission reception points are discussed in more detail with respect to FIG. 3.

FIG. 3 illustrates an example of a portion of a wireless communications system 300 that supports techniques for configuring channel state information (CSI) process for a coordinated set of transmission reception points in accordance with various aspects of the present disclosure. In some examples, wireless communications system 300 may implement aspects of wireless communication system 100. In wireless communications system 300, UE 115-e may be assigned to a serving geographical area 310 served by TRPs 105-e, 105-f, 105-g and 105-h. A first TRP 105-e may be a primary TRP that may perform communications with UE 115-e. In some aspects, a second TRP 105-f, a third TRP 105-g and/or a fourth TRP 105-g may form a CoMP set of TRPs 105 for serving the UE 115-e in certain situations. Coordinating entity 205-a may manage multiple serving geographical area 310 that may each include a number of different TRPs 105 and UEs 115. Communications between the coordinating entity 205-a and the TRPs 105-e 105-f, 105-g and/or 105-h may occur via communication links 320. The TRPs 105-e, 105-f, 105-g and/or 105-g may communicate with each other via channel 334 which may be an example of a backhaul link, TSN or other fast Ethernet-based network. In some examples, this communication channel 334 may operate at high speeds (e.g., 10 ns).

UE 115-e may be in communication with one or more TRPs 105 in the serving geographical area 301. For example, the UE 115-e may be in communication with TRP 105-e via communication link 325-a. In another example, the UE 115-e may be in communication with TRP 105-f via communication link 325-b. In other examples, the UE 115-e may be in communication with TRP 105-g via communication link 325-c. In another example, the UE 115-e may be in communication with TRP 105-h via communication link 325-d. In some cases, communication link 325-a between UE 115-e and TRP 105-e, communication link 325-b between UE 115-e and TRP 105-f, communication link 325-c between UE 115-e and TRP 105-g and/or communication link 325-d between UE 115-e and TRP 105-h may experience shadowing, which may result in a decreased received power of a signal communicated via communication link 325-a, communication link 325-b, communication link 325-c and/or communication link 325-d, respectively. The shadowing may be, for example, fast shadowing which may occur in an industrial IoT (IIoT) environment, for instance, due to various physical obstacles (e.g., due to a mechanical arm or other fast moving parts in the area). As a result of the shadowing, a large number of TRPs 105 may be needed for a CoMP set to serve the UE 115-e reliably. Because a large number of TRPs 105 may be needed for a CoMP set to reliably serving the UE 115-e, CSI processes may be needed from the large number of TRPs 105 in the CoMP set.

In order to efficiently obtain CSI from a large number of TRPs 105 in a CoMP set to reliably serving the UE 115-e, a first CoMP set of TRPs 105 may be identified based at least in part on a sounding reference signal (SRS) broadcasted by the UE 115-e. For example, the UE 115-e may broadcast a SRS to one or more neighboring TRPs 105 e, 105-f, 105-g and/or 105-h via communication link 325-a, communication link 325-b, communication link 325-c and/or communication link 325-d, respectively. Each of the one or more neighboring TRPs 105 e, 105-f, 105-g and/or 105-h may measure uplink channel quality of the communication link 325-a, communication link 325-b, communication link 325-c and/or communication link 325-d, respectively. In an example, each of the one or more neighboring TRPs 105 e, 105-f, 105-g and/or 105-h may provide the measured uplink channel quality of the communication link 325-a, communication link 325-b, communication link 325-c and/or communication link 325-d, respectively, to the coordinating entity 205-a. The coordinating entity 205-a may determine a first CoMP set of TRPs 105 based at least in part on measured uplink channel quality of the communication link 325-a, communication link 325-b, communication link 325-c and/or communication link 325-d. For example, the coordinating entity 205-a may include TRPs 105 having a measured uplink channel quality above a channel quality threshold in the first CoMP set.

In an aspect, the first CoMP set may include all TRPs 105 (e.g. TRPs 105-e, 105-f, 105-g and 105-h) that received the SRS from the UE 115-e. Also, all TRPs 105 (e.g. TRPs 105-e, 105-f, 105-g and 105-h) may have a measured uplink channel quality of the communication link 325-a, communication link 325-b, communication link 325-c and/or communication link 325-d above a channel quality threshold. In some aspects, the first CoMP set may include a subset of TRPs 105 (e.g. TRPs 105-e, 105-f, 105-g and 105-h). In an example, TRPs 105-e and 105-f may have a measured uplink channel quality above a channel quality threshold, while TRPs 105-g and 105-h may have a measured uplink channel quality below a channel quality threshold. Thus, the coordinating entity 205 may include TRPs 105-e and 105-f in the first CoMP set. By including a reduced number of TPRs 105 (e.g., TRPs 105-e and 105-f) instead of all the TRPs 105 (e.g. TRPs 105-e, 105-f, 105-g and 105-h) that received the SRS from the UE 115-e, a number of CSI processes (e.g., corresponding to different Tx state of TRPs) may be reduced. For example, sixteen (16) CSI processes (e.g., corresponding to different Tx state of TRPs) may be needed for all TRPs 105 (e.g. TRPs 105-e, 105-f, 105-g and 105-h) in the serving geographical area 310, while only four (4) CSI processes (e.g., corresponding to different Tx state of TRPs) may be needed for the reduced number of TRPs 105 (e.g., TRPs 105-e and 105-f) in the first CoMP set. Thus, a number of CSI processes (e.g., corresponding to different Tx state of TRPs) needed for the first CoMP set of TRPs 105 (e.g. TRPs 105-e and 105-f) may be reduced based at least in part on the SRS.

In some aspects, the TRPs 105 (e.g. TRPs 105-e, 105-f, 105-g and 105-h) may provide the measured uplink channel quality of the communication link 325-a, communication link 325-b, communication link 325-c and/or communication link 325-d to each other. The TRPs 105 (e.g. TRPs 105-e, 105-f, 105-g and 105-h) may negotiate amongst each other to determine a first CoMP set of TRPs 105. For example, the TRPs 105 (e.g. TRPs 105-e, 105-f, 105-g and 105-h) may provide the measured uplink channel quality to each other via channel 334. The TRPs 105 (e.g. TRPs 105-e, 105-f, 105-g and 105-h) may identify one or more TRPs 105 that may have a measured uplink channel quality above a channel quality threshold. For example, the one or more TRPs 105 (e.g., TRPs 105-g and 105-h) that have a measured uplink channel quality above a channel quality threshold may form the first CoMP set of TRPs 105 to serve the UE 115-e.

In some aspects, although uplink channel quality may be determined, more detailed channel state information may be needed in order to maintain a reliable CoMP set of TRPs due to change in the environment (e.g., fast shadowing). A number of combinations of CSI processes (e.g., corresponding to different Tx state of TRPs) may be identified for the first CoMP set of TRPs 105. The number of combinations of CSI processes (e.g., corresponding to different Tx state of TRPs) may be based at least in part on a number of TRPs 105 in the first CoMP set. For example, if the first CoMP set of TRPs 105 may include two TRPs (e.g., TRPs 105-e and 105-f), four (4) combinations of CSI processes (e.g., corresponding to different Tx state of TRPs) may be identified. The four combinations of CSI processes (e.g., corresponding to different Tx state of TRPs) may include a first combination of no transmission from TRPs 105-e and 105-f, a second combination of transmission from TRP 105-e and no transmission from TRP 105-f, a third combination of no transmission from TRP 105-e and transmission from TRP 105-f and a fourth combination of transmissions from TRPs 105-e and 105-f. In another example, if the first CoMP set of TRPs 105 may include three TRPs 105 (e.g., TRPs 105-e, 105-f and 105-g), eight (8) combinations of CSI processes (e.g., corresponding to different Tx state of TRPs) may be identified. In other examples, if the first CoMP set of TRPs 105 may include four TRPs 105 (e.g., TRPs 105-e, 105-f, 105-g and 105-h), sixteen (16) combinations of CSI processes (e.g., corresponding to different Tx state of TRPs) may be identified.

In some aspects, a subset combinations of CSI processes (e.g., corresponding to different Tx state of TRPs) may be identified for the first CoMP set of TRPs 105. As discussed above, a total of four combinations of CSI processes, eight combinations of CSI processes, and sixteen combinations of CSI processes may be identified when the first CoMP set of TRPs 105 includes two TRPs 105, three TRPs 105 and/or four TRPs 105, respectively. However, a subset combinations of CSI processes (e.g., corresponding to different Tx state of TRPs) may be identified as more detailed channel state information needed to maintain a reliable CoMP set of TRPs 105 due to the change in the environment (e.g., fast shadowing). For example, when the first CoMP set of TRPs 105 includes two TRPs 105-e and 105-f, a subset (e.g., three out of four) combinations of CSI processes (e.g., corresponding to different Tx state of TRPs) may be identified. In an example, the subset combinations of CSI processes (e.g., corresponding to different Tx state of TRPs) may include the second combination of transmission from TRP 105-e and no transmission from TRP 105-f, the third combination of no transmission from TRP 105-e and transmission from TRP 105-f and a fourth combination of transmissions from TRPs 105-e and 105-f. In another example, the subset combinations of CSI processes (e.g., corresponding to different Tx state of TRPs) may include the second combination of transmission from TRP 105-e and no transmission from TRP 105-f and the third combination of no transmission from TRP 105-e and transmission from TRP 105-f.

For example, CSI process may include each of the TRPs 105 in the first CoMP set may transmit a channel state information reference signal (CSI-RS) to the UE 115-e. The UE 115-e may measure a channel condition using the CSI-RS and report the channel condition (e.g., channel quality indicator (CQI)) to each of the TRPs in the first CoMP set. Each TRPs 105 in the first CoMP set may determine a CSI interference measurement (CSI-IM) based at least in part on the channel condition report provided by the UE 115-e. Each of the TRPs 105 in the first CoMP set may provide/report the CSI-IM to the coordinating entity 205-a. The coordinating entity 205-a may determine a second CoMP set of TRPs 105 for communication with UE 115-e based at least in part on the CSI-IM provided by each TRPs 105 in the first CoMP set. In another example, the TRPs 105 in the first CoMP set may provide/report the CSI-IM to each other in order to determine a second CoMP set of TRPs 105 to serve the UE 115-e. The second CoMP set of TRPs 105 may serve the UE 115-e in a reliable manner.

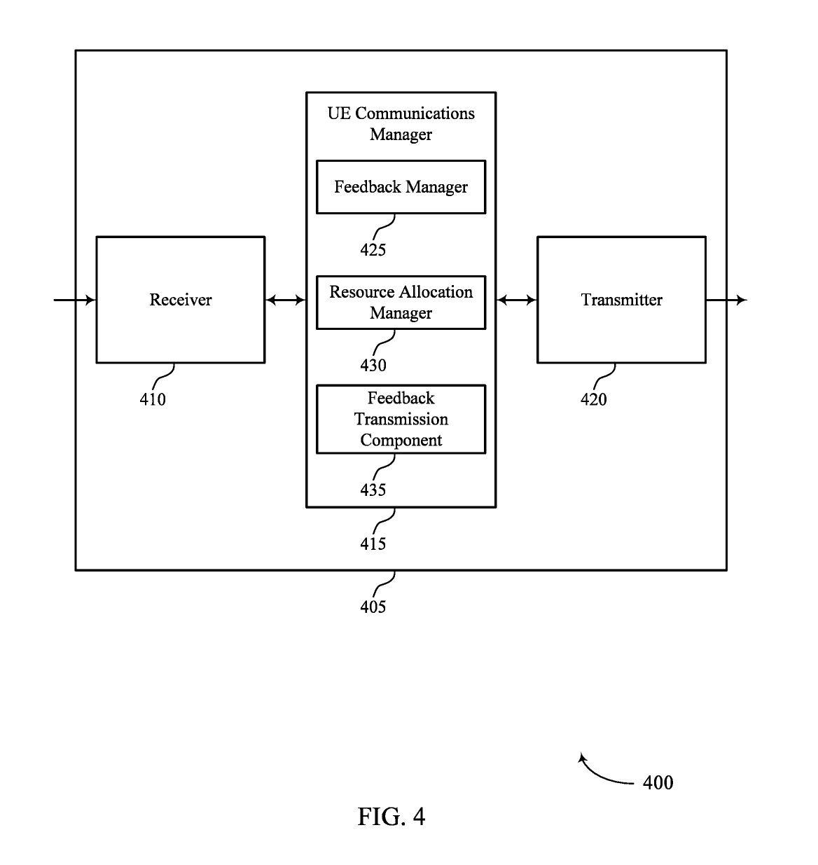

FIG. 4 shows a block diagram 400 of a wireless device 405 that supports techniques for configuring channel state information (CSI) process for a coordinated set of transmission reception points in accordance with aspects of the present disclosure. Wireless device 405 may be an example of aspects of a UE 115 as described with reference to FIGS. 1-3. Wireless device 405 may include a receiver 410, a UE communications manager 415, and a transmitter 420. Wireless device 405 may also include a processor. Each of these components may be in communication with one another (e.g., via one or more buses).

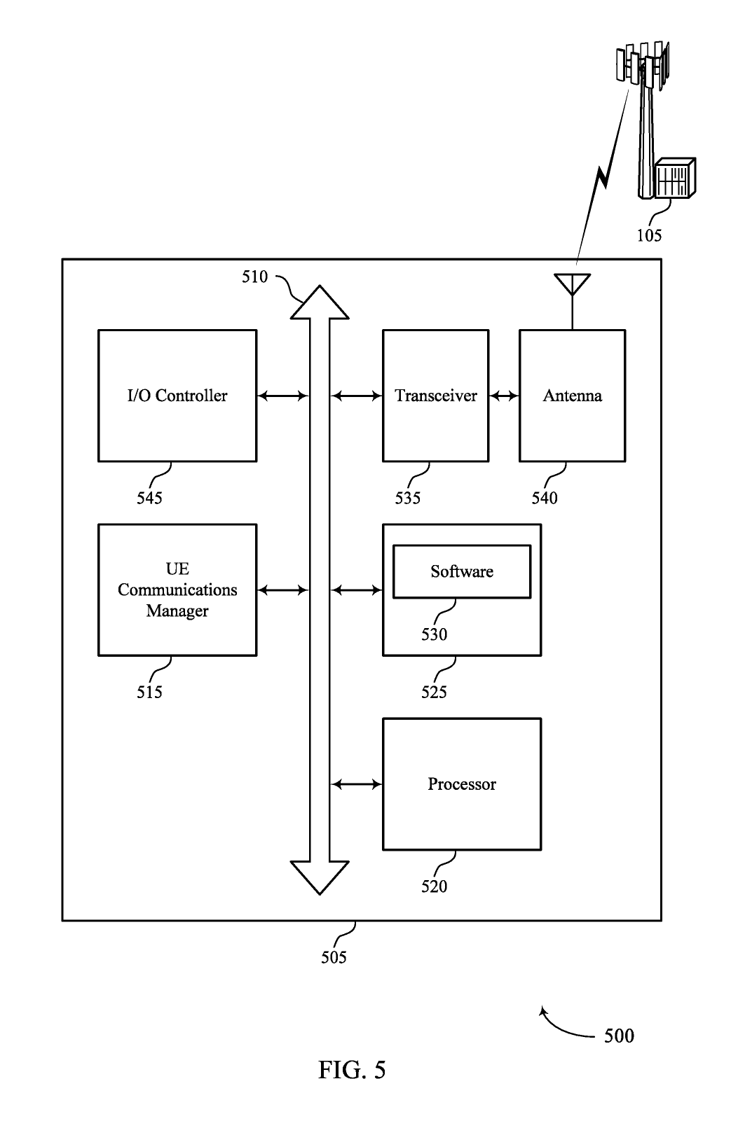

Receiver 410 may receive information such as packets, user data, or control information associated with various information channels (e.g., control channels, data channels, and information related to feedback transmission techniques in coordinated sets of transmission reception points, etc.). Information may be passed on to other components of the device. The receiver 410 may be an example of aspects of the transceiver 535 described with reference to FIG. 5. The receiver 410 may utilize a single antenna or a set of antennas.

UE communications manager 415 may be an example of aspects of the UE communications manager 515 described with reference to FIG. 5. UE communications manager 415 may also include sounding reference signal (SRS) manager 425, CSI process manager 430, and CSI feedback transmission component 435.

SRS manager 425 may broadcast one or more sounding reference signals (SRS) to one or more neighboring TRPs 105.

CSI process manager 430 may identify all combinations of CSI processes of a first CoMP set of TRPs 105. In another example, the CSI process manager 430 may identify a subset combinations of CSI processes of a first CoMP set of TRPs 105. In some aspects, the CSI process manager 430 may receive channel state information reference signal (CSI-RS) from one or more TRPs 105 of the first CoMP set of TRPs 105. The CSI-RS received from the one or more TRPs 105 of the first CoMP set of TRPs 105 may be based at least in part on the identified CSI processes.

CSI Feedback transmission component 435 may report/transmit, based on the received CSI-RS, the NCSI to the one or more TRPs 105 of the first CoMP set of TRPs 105.

Transmitter 420 may transmit signals generated by other components of the wireless device 400. In some examples, the transmitter 420 may be collocated with a receiver 410 in a transceiver module. For example, the transmitter 420 may be an example of aspects of the transceiver 535 described with reference to FIG. 5. The transmitter 520 may utilize a single antenna or a set of antennas.

FIG. 5 shows a diagram of a system 500 including a wireless device 505 that supports techniques configuring channel state information (CSI) process for a coordinated set of transmission reception points in accordance with aspects of the present disclosure. Wireless device 505 may be an example of or include the components of wireless device 405, or a UE 115 as described above, e.g., with reference to FIGS. 1-4. Wireless device 505 may include components for bi-directional voice and data communications including components for transmitting and receiving communications, including UE communications manager 515, processor 520, memory 525, software 530, transceiver 535, antenna 540, and I/O controller 545. These components may be in electronic communication via one or more buses (e.g., bus 510). Wireless device 505 may communicate wirelessly with one or more base stations 105.

Processor 520 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 520 may be configured to operate a memory array using a memory controller. In other cases, a memory controller may be integrated into processor 520. Processor 520 may be configured to execute computer-readable instructions stored in a memory to perform various functions (e.g., functions or tasks supporting feedback transmission techniques in coordinated sets of transmission reception points).

Memory 525 may include random access memory (RAM) and read only memory (ROM). The memory 525 may store computer-readable, computer-executable software 530 including instructions that, when executed, cause the processor to perform various functions described herein. In some cases, the memory 525 may contain, among other things, a basic input/output system (BIOS) which may control basic hardware or software operation such as the interaction with peripheral components or devices.

Software 530 may include code to implement aspects of the present disclosure, including code to support techniques for configuring channel state information (CSI) process for a coordinated set of transmission reception points. Software 530 may be stored in a non-transitory computer-readable medium such as system memory or other memory. In some cases, the software 530 may not be directly executable by the processor but may cause a computer (e.g., when compiled and executed) to perform functions described herein.

Transceiver 535 may communicate bi-directionally, via one or more antennas, wired, or wireless links as described above. For example, the transceiver 535 may represent a wireless transceiver and may communicate bi-directionally with another wireless transceiver. The transceiver 535 may also include a modem to modulate the packets and provide the modulated packets to the antennas for transmission, and to demodulate packets received from the antennas.

In some cases, the wireless device 505 may include a single antenna 540. However, in some cases the device may have more than one antenna 540, which may be capable of concurrently transmitting or receiving multiple wireless transmissions.

I/O controller 545 may manage input and output signals for wireless device 505. I/O controller 545 may also manage peripherals not integrated into wireless device 505. In some cases, I/O controller 545 may represent a physical connection or port to an external peripheral. In some cases, I/O controller 545 may utilize an operating system such as iOS®, ANDROID®, MS-DOS®, MS-WINDOWS®, OS/2®, UNIX®, LINUX®, or another known operating system. In other cases, I/O controller 545 may represent or interact with a modem, a keyboard, a mouse, a touchscreen, or a similar device. In some cases, I/O controller 545 may be implemented as part of a processor. In some cases, a user may interact with wireless device 505 via I/O controller 545 or via hardware components controlled by I/O controller 545.

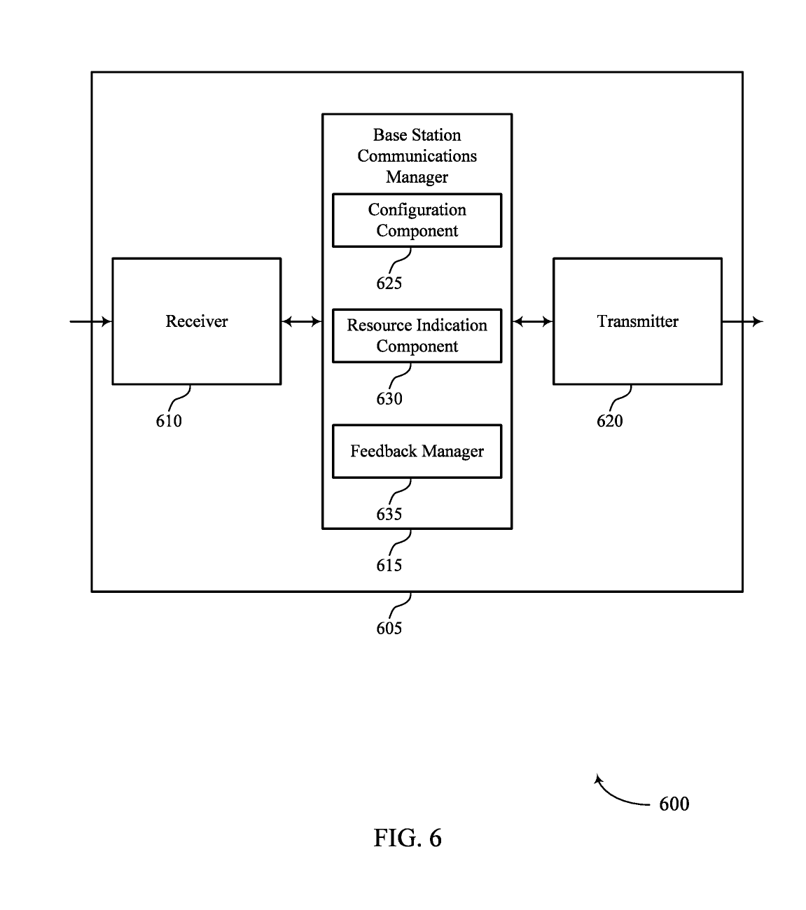

FIG. 6 shows a block diagram 600 of a wireless device 605 that supports techniques for configuring channel state information (CSI) process for a coordinated set of transmission reception points in accordance with aspects of the present disclosure. Wireless device 605 may be an example of aspects of a base station 105 as described with reference to FIGS. 1-3. Wireless device 605 may include receiver 610, base station communications manager 615, and transmitter 620. Wireless device 605 may also include a processor. Each of these components may be in communication with one another (e.g., via one or more buses).

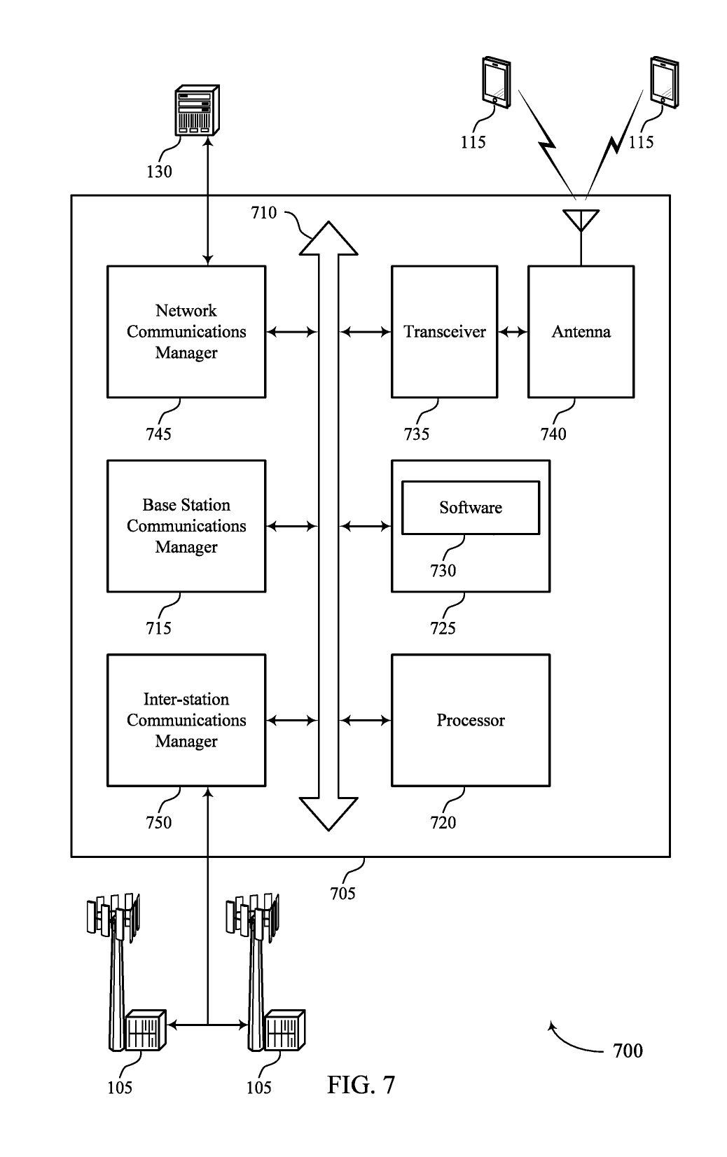

Receiver 610 may receive information such as packets, user data, or control information associated with various information channels (e.g., control channels, data channels, and information related to techniques for configuring channel state information (CSI) process for a coordinated set of transmission reception points, etc.). Information may be passed on to other components of the wireless device 605. The receiver 610 may be an example of aspects of the transceiver 735 described with reference to FIG. 7. The receiver 610 may utilize a single antenna or a set of antennas.

Base station communications manager 615 may be an example of aspects of the base station communications manager 715 described with reference to FIG. 7. Base station communications manager 715 may also include SRS component 625, CSI process component 630, and CoMP set manager 635.

SRS component 625 may receive one or more SRS from a UE 115. The SRS component 625 may measure an uplink channel quality of an uplink communication link between the wireless device 605 and one or more TRPs 105.

CSI process component 630 may identify a first CoMP set of TRPs 105 based at least in part on the SRS. For example, the CSI process component 630 may identify a first CoMP set of TRPs 105 based at least in part on a measured uplink channel quality from the received SRS. In an example, the CSI process component 630 may identify all combinations of CSI processes for the first CoMP set of TRPs 105. In another example, the CSI process component 630 may identify a subset combinations of CSI processes for the first CoMP set of TRPs 105. The CSI process component 630 may transmit one or more CSI-RS based at least in part on the identified CSI processes. Subsequently, the CSI process component 630 may receive CSI feedback from the UE 115 based at least in part on the CSI-RS.

CoMP set manager 635 may identify a first CoMP set of TRPs 105 based at least in part on the received SRS. For example, the CoMP set manager 635 may include one or more TRPs 105 in a first CoMP set of TRPs 105 when the one or more TRPs 105 have a measured uplink channel quality above a channel quality threshold. The CoMP set manager 635 may identify a second CoMP set of TRPs 105 based at least in part on the CSI feedback received from the UE 115.

Transmitter 620 may transmit signals generated by other components of the device. In some examples, the transmitter 620 may be collocated with a receiver 610 in a transceiver module. For example, the transmitter 620 may be an example of aspects of the transceiver 735 described with reference to FIG. 7. The transmitter 720 may utilize a single antenna or a set of antennas.

FIG. 7 shows a diagram of a system 700 including a wireless device 705 that supports techniques for configuring channel state information (CSI) process for a coordinated set of transmission reception points in accordance with aspects of the present disclosure. Wireless device 705 may be an example of or include the components of base station 105 as described above, e.g., with reference to FIGS. 1-3. Wireless device 705 may include components for bi-directional voice and data communications including components for transmitting and receiving communications, including base station communications manager 715, processor 720, memory 725, software 730, transceiver 735, antenna 740, network communications manager 745, and inter-station communications manager 750. These components may be in electronic communication via one or more buses (e.g., bus 710). Wireless device 705 may communicate wirelessly with one or more UEs 115.

Processor 720 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting techniques for configuring channel state information (CSI) process for a coordinated set of transmission reception points).

Memory 725 may include RAM and ROM. The memory 725 may store computer-readable, computer-executable software 730 including instructions that, when executed, cause the processor to perform various functions described herein. In some cases, the memory 725 may contain, among other things, a BIOS which may control basic hardware or software operation such as the interaction with peripheral components or devices.

Software 730 may include code to implement aspects of the present disclosure, including code to support techniques for configuring channel state information (CSI) process for a coordinated set of transmission reception points. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device 705 may include a single antenna 740. However, in some cases the wireless device 705 may have more than one antenna 740, which may be capable of concurrently transmitting or receiving multiple wireless transmissions.

Network communications manager 745 may manage communications with the core network (e.g., via one or more wired backhaul links). For example, the network communications manager 745 may manage the transfer of data communications for client devices, such as one or more UEs 115.

Inter-station communications manager 750 may manage communications with other base station 105, and may include a controller or scheduler for controlling communications with UEs 115 in cooperation with other base stations 105. For example, the inter-station communications manager 750 may coordinate scheduling for transmissions to UEs 115 for various interference mitigation techniques such as beamforming or joint transmission. In some examples, inter-station communications manager 750 may provide an X2 interface within an Long Term Evolution (LTE)/LTE-A wireless, new radio (NR) communication network technology to provide communication between base stations 105.

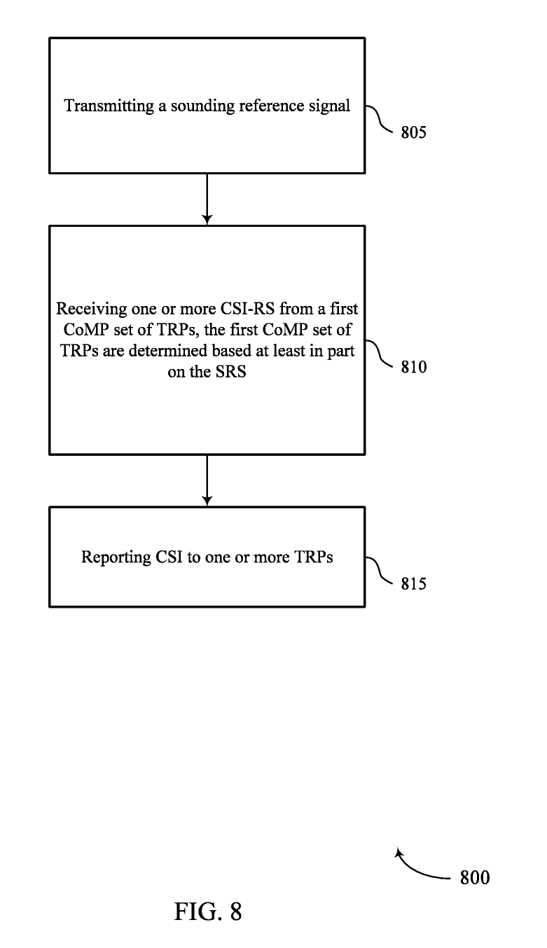

FIG. 8 shows a flowchart illustrating a method 800 for techniques for configuring channel state information (CSI) process for a coordinated set of transmission reception points in accordance with aspects of the present disclosure. The operations of method 800 may be implemented by a UE 115 or its components as described herein. For example, the operations of method 800 may be performed by a UE communications manager as described with reference to FIGS. 4 and 5. In some examples, a UE 115 may execute a set of codes to control the functional elements of the device to perform the functions described below. Additionally or alternatively, the UE 115 may perform aspects of the functions described below using special-purpose hardware.

At 805 the UE 115 may transmit or broadcast a sounding reference signal (SRS) to one or more neighboring TRPs 105. The operations of 805 may be performed according to the methods described herein. In certain examples, aspects of the operations of 805 may be performed by a SRS manager as described with reference to FIGS. 4 and 5.

At 810 the UE 115 may receive one or more channel state information reference signals (CSI-RS) from a first coordinated multiple-point (CoMP) set of TRPs 105. For example, the first CoMP set of transmission points may be determined based at least in part on the transmitted or broadcasted SRS. The operations of 810 may be performed according to the methods described herein. In certain examples, aspects of the operations of 810 may be performed by a CSI process manager as described with reference to FIGS. 4 and 5.

At 815 the UE 115 may transmit or report channel state information (CSI) to the one or more TRPs 105 of the first CoMP set of TRPs 105. The operations of 815 may be performed according to the methods described herein. In certain examples, aspects of the operations of 815 may be performed by a CSI feedback transmission component as described with reference to FIGS. 4 and 5.

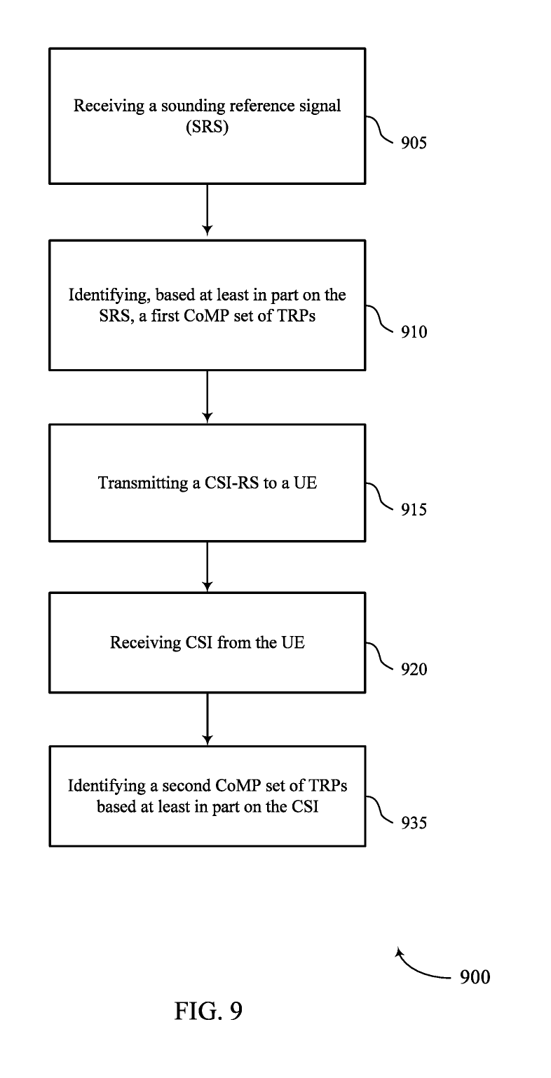

FIG. 9 shows a flowchart illustrating a method 900 to support techniques for configuring channel state information (CSI) process for a coordinated set of transmission reception points in accordance with aspects of the present disclosure. The operations of method 900 may be implemented by a base station 105 or its components as described herein. For example, the operations of method 900 may be performed by a base station communications manager as described with reference to FIGS. 6 and 7. In some examples, a base station 105 may execute a set of codes to control the functional elements of the device to perform the functions described below. Additionally or alternatively, the base station 105 may perform aspects of the functions described below using special-purpose hardware.

At 905 the base station 105 may receive a sounding reference signal (SRS) from a UE 115. The operations of 905 may be performed according to the methods described herein. In certain examples, aspects of the operations of 905 may be performed by a SRS component as described with reference to FIGS. 6 and 7.

At 910 the base station 105 may identify a first CoMP set of TRPs 105 based at least in part on the received SRS. For example, the first CoMP set of TRPs 105 may include one or more TRPs 105 that have a measured uplink channel quality, based at least in part on the received SRS, above a channel quality threshold. The operations of 910 may be performed according to the methods described herein. In certain examples, aspects of the operations of 910 may be performed by a CoMP set manager as described with reference to FIGS. 6 and 7.

At 915 the base station 105 may transmit a channel state information reference signal (CSI-RS) to the UE 115. For example, the one or more TRPs 105 in the first CoMP set of TRPs 105 may transmit a CSI-Rs to the UE 115. The operations of 915 may be performed according to the methods described herein. In certain examples, aspects of the operations of 915 may be performed by a CSI process component as described with reference to FIGS. 6 and 7.

At 920 the base station 105 may receive channel station information (CSI) from the UE 115 based at least in part on the CSI-RS. The operations of 920 may be performed according to the methods described herein. In certain examples, aspects of the operations of 920 may be performed by a CSI process component as described with reference to FIGS. 6 and 7.

At 925 the base station 105 may identify a second CoMP set of TRPs 105. For example, the second CoMP set of TRPs 105 may be identified based at least in part on the received CSI from the UE 115. The operations of 925 may be performed according to the methods described herein. In certain examples, aspects of the operations of 925 may be performed by a CoMP set manager as described with reference to FIGS. 6 and 7.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving a sounding reference signal (SRS);
identifying, based at least in part on the SRS, a first coordinated multiple-point (CoMP) set of transmission points;
transmitting a channel state information reference signal (CSI-RS) to a user equipment (UE);
receiving channel state information (CSI) from the UE; and
identifying, based at least in part on the CSI, a second CoMP set of transmission points.

2. The method of claim 1, wherein the first CoMP set of transmission points includes a subset of a plurality of transmission points that received the SRS.

3. The method of claim 1, wherein the first CoMP set of transmission points includes all of a plurality of transmission points that received the SRS.

4. The method of claim 1, further comprising:
identifying one or more CSI processes for the first CoMP set of transmission points.

5. The method of claim 4, wherein identifying one or more CSI processes for the first CoMP set of transmission points comprises:
identifying all combinations of CSI processes for a plurality of transmission points of the first CoMP set of transmission points.

6. The method of claim 4, wherein identifying one or more CSI processes for the first CoMP set of transmission points comprises:
identifying a subset combination of CSI processes for a plurality of transmission points of the first CoMP set of transmission points.

7. The method of claim 1, wherein the first CoMP set of transmission points includes a great number of transmission points than the second CoMP set of transmission points.

8. A method for wireless communication, comprising:
transmitting, by a user equipment, a sounding reference signal (SRS);
receiving, by the user equipment, one or more channel state information reference signals (CSI-RS) from a first coordinated multiple-point (CoMP) set of transmission points, the first CoMP set of transmission points are determined based at least in part on the SRS; and
reporting, by the user equipment, channel state information (CSI) to the one or more transmission points.

9. The method of claim 8, wherein the one or more transmission points include a subset of a plurality of transmission points that received the SRS.

10. The method of claim 8, wherein the one or more transmission points include all of a plurality of transmission points that received the SRS.

11. The method of claim 8, further comprising:
receiving CoMP transmissions from a second CoMP set of transmission points, the second CoMP set of transmission points is different from the first CoMP set of transmission points.

12. An apparatus for wireless communication, comprising:
a processor;
a memory in communication with the processor; and
instructions stored in the memory and executable by the processor to cause the apparatus to:
receive a sounding reference signal (SRS);
identify, based at least in part on the SRS, a first coordinated multiple-point (CoMP) set of transmission points;
transmit a channel state information reference signal (CSI-RS) to a user equipment (UE);
receive channel state information (CSI) from the UE; and
identify, based at least in part on the CSI, a second CoMP set of transmission points.

13. The apparatus of claim 12, wherein the first CoMP set of transmission points includes a subset of a plurality of transmission points that received the SRS.

14. The apparatus of claim 12, wherein the first CoMP set of transmission points includes all of a plurality of transmission points that received the SRS.

15. The apparatus of claim 12, wherein the instructions are further executable by the processor to cause the apparatus to:
identify one or more CSI processes for the first CoMP set of transmission points.

16. The apparatus of claim 15, wherein identify one or more CSI processes for the first CoMP set of transmission points comprises:
identifying all combinations of CSI processes for a plurality of transmission points of the first CoMP set of transmission points.

17. The apparatus of claim 15, wherein identify one or more CSI processes for the first CoMP set of transmission points comprises:
identifying a subset combination of CSI processes for a plurality of transmission points of the first CoMP set of transmission points.

18. The apparatus of claim 12, wherein the first CoMP set of transmission points includes a great number of transmission points than the second CoMP set of transmission points.

19. An apparatus for wireless communication, comprising:
a processor;
a memory in communication with the processor; and
instructions stored in the memory and executable by the processor to cause the apparatus to:
transmit a sounding reference signal (SRS);
receive one or more channel state information reference signals (CSI-RS) from a first coordinated multiple-point (CoMP) set of transmission points, the first CoMP set of transmission points are determined based at least in part on the SRS; and
report channel state information (CSI) to the one or more transmission points.

20. The apparatus of claim 19, wherein the one or more transmission points include a subset of a plurality of transmission points that received the SRS.

21. The apparatus of claim 19, wherein the one or more transmission points include all of a plurality of transmission points that received the SRS.

22. The apparatus of claim 19, wherein the instructions are further executable by the processor to cause the apparatus to:
receive CoMP transmissions from a second CoMP set of transmission points, the second CoMP set of transmission points is different from the first CoMP set of transmission points.
